(19) United States
(12) Patent Application Publication
(10) Pub. No.: US 2009/0174718 A1
(43) Pub. Date: Jul. 9, 2009

(54) SETTING METHODS AND MOTHERBOARD FOR DISPLAY PARAMETERS

(75) Inventors: Cheng-Hsun Li, Taipei (TW); CHIY-FERNG PERNG, TAIPEI (TW)

Correspondence Address: QUINTERO LAW OFFICE, PC, 2210 MAIN STREET, SUITE 200, SANTA MONICA, CA, 90405, US

(73) Assignee: ASUSTEK COMPUTER INC., TAIPEI CITY (TW)

(21) Appl. No.: 12/239,004

(22) Filed: Sep. 26, 2008

(30) Foreign Application Priority Data
Jan. 4, 2008 (TW) TW97100319

(51) Int. Cl. G06F 15/00

(52) U.S. Cl. 345/501

(57) ABSTRACT

Setting methods and motherboard for display parameters are provided. A display card is sought. If the display card is identified, a default parameter for display is accessed and stored to a BIOS via a bus. Then, the default parameter is adjusted to a modified parameter. After the default parameter is adjusted to the modified parameter, the display card accesses and executes the modified parameter.

### CROSS REFERENCE TO RELATED APPLICATIONS

This Application claims priority of Taiwan Patent Application No. 97100319, filed on Jan. 4, 2008, the entirety of which is incorporated by reference herein.

### BACKGROUND OF THE INVENTION

1. Field of the Invention

The disclosure relates generally to setting methods, motherboards and electronic devices for VGA (Video Graphics Array) display parameters, and, more particularly to methods, motherboards and electronic devices that set display parameters using a BIOS (Basic Input/Output System) via a bus.

2. Description of the Related Art

In electronic devices, such as computer systems, display devices are employed to display related information. A display card, such as VGA card is an element performing the display control of the display device.

Generally, the VGA card can provide an interface for users to set related parameters. Conventionally, when the VGA parameters need to be adjusted, the electronic device must first boot up, and load an OS (Operating System) therein. Then, a driver corresponding to the VGA card is installed. Users can adjust and set the VGA parameters via the driver. Since it takes time to wait for the boot up procedure of the electronic device to be completed, and not all users understand how to install and use drivers, the conventional setting method for VGA parameters is inconvenient for users.

### BRIEF SUMMARY OF THE INVENTION

Setting methods and motherboards for display parameters are provided.

In an embodiment of a setting method for display parameters, a display card is sought. If the display card is identified, a default parameter for display is accessed and stored to a BIOS via a bus. Then, the default parameter is adjusted to a modified parameter. After the default parameter is adjusted to the modified parameter, the display card accesses and executes the modified parameter.

An embodiment of a motherboard comprises a bus and a BIOS. The motherboard connects with a display card having a setting data recording unit recording at least a default parameter. The bus connects with the display card. The BIOS access the default parameter in the setting data recording unit via the bus. After the default parameter is replaced by a modified parameter, the display card accesses and executes the modified parameter.

Setting methods for display parameters may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an electronic device for setting display parameters of the invention; and

FIG. 2 is a flowchart of an embodiment of a setting method for display parameters of the invention.

### DETAILED DESCRIPTION OF THE INVENTION

Setting methods and motherboards for display parameters are provided.

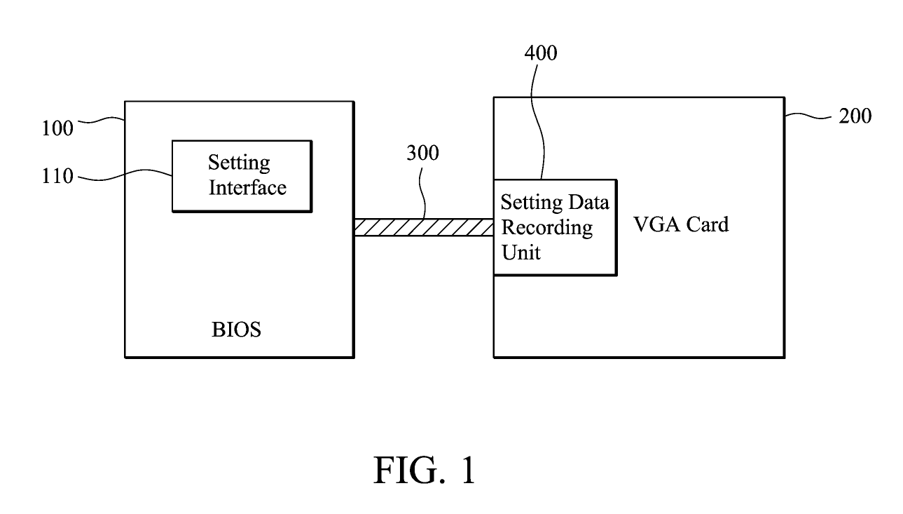

FIG. 1 is a schematic diagram illustrating an embodiment of an electronic device for setting display parameters of the invention.

The electronic device for setting display parameters may be a computer system, an electronic game console, or a motherboard. As shown in FIG. 1, the electronic device for setting display parameters comprises a BIOS 100, a VGA card (or display card) 200, a bus 300, and a setting data recording unit 400.

The BIOS 100 is firmware stored in the ROM (Read Only Memory) of the motherboard of the electronic device. The BIOS 100 mainly provides basic input and output capabilities, basic functions, and performance of hardware testing for the computer system. The BIOS 100 comprises a setting interface 110. The setting interface 110 can display default parameters provided by the VGA card 200, and corresponding setting items. The default parameters of the VGA card 200 comprise performance, fan speed, and/or operating frequency. The VGA card 200 is used for display control. It is understood that, in this embodiment, the VGA card is an independent display card. However, in some embodiments, the VGA card 200 can be a chip directly set on the motherboard. The setting data recording unit 400 is set on the VGA card 200, and stores the default parameters of the VGA card 200, and related setting values. It is noted that, in this embodiment, the setting data recording unit 400 is set on the VGA card 200. However, in some embodiments, the setting data recording unit 400 can be an independent chip, or a storage unit, such as a flash memory or EEPROM. The bus 300 can be a SMBus (System Management Bus) or an I2C (Inter-Integrated Circuit) Bus. The BIOS 100 can access the default parameters of the VGA card 200 and related setting values via the bus 300, and transmit modified parameters received via the setting interface 110 to the setting data recording unit 400. The modified parameters can be input by users using the setting interface 110. The VGA card 200 can execute and perform display control for the electronic device according to the modified parameters.

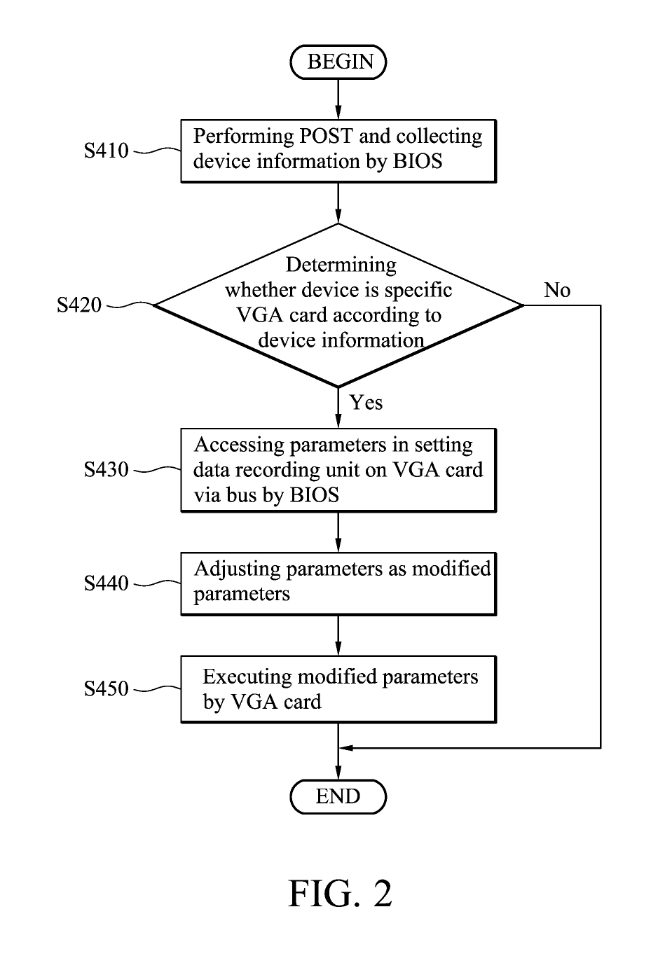

FIG. 2 is a flowchart of an embodiment of a setting method for display parameters of the invention.

When the electronic device boots up, in step S410, the BIOS 100 performs POST (Power-On Self Test), and collects device information of at least one device in the electronic device during POST. The device information can comprise device type and identification code. In step S420, it is determined whether the device is a specific VGA card according to the device information. That is, it is determined whether the device is a VGA card 200 having a default parameter or an identification of a specific company. If the device is not the specific VGA card (No in step S420), the procedure is completed. If the device is the specific VGA card (Yes in step S420), in step S430, the BIOS 100 accesses the parameters, such as performance, fan speed, and/or operating frequency in the setting data recording unit 400 on the VGA card 200 via the bus 300, such as an SMBus or I2C bus. In some embodiments, the parameters accessed by the BIOS 100 can be displayed in the setting interface 110 to notify users. In step S440, a user adjusts and sets the parameters as modified parameters via the setting interface 110. In step S450, the VGA card 100 reads and executes the modified parameters, and performs display control for the electronic device according to the modified parameters. It is understood that, after the user adjusts the parameters as the modified parameters via the setting interface 110, the BIOS 100 can first store the modified parameters to the setting data recording unit 400 via the bus 300. Then, when the VGA card operates, the modified parameters are obtained from the setting data recording unit 400 for execution.

Setting methods for display parameters, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A motherboard connected with a display card, where the display card comprises a setting data recording unit storing at least one default parameter, comprising:
a bus connecting with the display card; and
a BIOS accessing the default parameter via the bus,
wherein after the default parameter is replaced by a modified parameter, the display card accesses and executes the modified parameter.

2. The motherboard of claim 1, wherein the BIOS further provides a setting interface to display the default parameter accessed by the BIOS via the bus, and when the modified parameter is received via the setting interface, the default parameter is replaced by the modified parameter.

3. The motherboard of claim 1, wherein if the default parameter is not replaced, the display card executes the default parameter.

4. The motherboard of claim 1, wherein the bus is a SMBus (System Management Bus).

5. The motherboard of claim 1, wherein the bus is an I2C (Inter-Integrated Circuit) bus.

6. The motherboard of claim 1, wherein the default parameter is a fan speed.

7. The motherboard of claim 1, wherein the default parameter is an operating frequency.

8. The motherboard of claim 1, wherein the BIOS stores the modified parameter to the setting data recording unit via the bus, and when the display card operates, the display card obtains the modified parameter from the setting data recording unit for execution.

9. A setting method for display parameters, comprising:
seeking a display card;
if the display card is identified, accessing a default parameter corresponding to the display card to a BIOS via a bus; and
when the default parameter is adjusted to a modified parameter, accessing and executing the modified parameter by the display card.

10. The method of claim 9, further comprising performing a POST (Power-On Self Test) by the BIOS before the step of seeking the display card.

11. The method of claim 9, wherein the step of adjusting the default parameter as the modified parameter is performed by displaying the default parameter accessed by the BIOS via the bus in a setting interface provided by the BIOS, and receiving the modified parameter via the setting interface to replace the default parameter.

12. The method of claim 9, wherein the bus is a SMBus (System Management Bus).

13. The method of claim 9, wherein the bus is an I2C (Inter-Integrated Circuit) bus.

14. The method of claim 9, wherein the default parameter is a fan speed.

15. The method of claim 9, wherein the default parameter is an operating frequency.

16. The method of claim 9, wherein the step of accessing and executing the modified parameters by the display card is performed by storing the modified parameter to a setting data recording unit via the bus by the BIOS, and when the display card operates, obtaining the modified parameter from the setting data recording unit for execution by the display card.
